(19) United States
(12) Patent Application Publication
(10) Pub. No.: US 2003/0152690 A1
(43) Pub. Date: Aug. 14, 2003

(54) Method for operating and controlling electroless plating

(76) Inventors: Yuh Sung, Chung-Li City (TW); Te-Hui Cheng, Kaohsiung Hsien (TW); Ming-Der Ger, Taoyuan Hsien (TW); Le-Min Weng, Taoyuan Hsien (TW); Bing-Joe Hwang, Taipei City (TW)

Correspondence Address: BACON & THOMAS, PLLC, 625 SLATERS LANE, FOURTH FLOOR, ALEXANDRIA, VA, 22314

(21) Appl. No.: 10/067,259

(22) Filed: Feb. 7, 2002

(51) Int. Cl. B05D 1/18

(52) U.S. Cl. 427/8; 427/443.1

(57) ABSTRACT

The present invention discloses a method for operating and controlling electroless plating, which comprises plating a substrate with a plating solution, the substrate is controlled at a constant temperature between 25° C. to 200° C., and the plating solution is kept at a lower temperature than that of the substrate. According to the method of the present invention, superior depositing rates can be achieved, undesired spontaneous decomposition of the plating solution at high temperature can be avoided and no stabilizers are necessary.

### BACKGROUND OF THE INVENTION

1. Field of the Invention

The present invention relates to a method for operating and controlling electroless plating and, more particularly, to a method for operating and controlling electroless plating under non-homogeneous heating.

2. Description of the Related Art

Since created by Brenner and Riddle in 1946, electroless plating of chemical nickel is always operated under homogeneous temperature. Some reports indicate that local over-heating of an electroless plating solution may suffer problems, such as worsening characteristics of deposits and spontaneous decomposition of the baths.

To solve the above problem, stabilizers are necessary for the baths. However, the activity of the catalytic substrate is altered appreciably by extremely minute concentrations of stabilizer, so that it is embarrassing to govern it in plating solution bath. In general, excessive stabilizers can result in decreasing plating rate as well as loss property of deposits, and insufficient stabilizers may accelerate the depositing rates too fast to keep the quality of deposits or even spontaneously decompose plating baths.

Accordingly, there is a need for the above conventional method to be improved.

### SUMMARY OF THE INVENTION

The object of the present invention is to provide a method for operating and controlling electroless plating, so that superior depositing rates and deposits with better characteristics can be obtained.

Another object of the present invention is to provide a method for operating and controlling electroless plating, so that undesired spontaneous decomposing of plating bath at high temperature can be avoided, and no stabilizers are necessary.

In order to achieve the above objects, the method in accordance with the present invention is primarily to plate a substrate with an electroless plating solution, wherein the substrate is heated at constant temperature, and the solution is kept at a lower temperature than that of the substrate.

The method of the present invention comprises plating a substrate with a plating solution, the substrate is controlled at a constant temperature between 25° C. to 200° C., and the plating solution is kept at a lower temperature than the temperature of the substrate. Preferably, the temperature of the substrate is controlled at a temperature between 90° C. and 160° C., and the temperature of the plating solution is controlled at a temperature between 25° C. to 80° C.

The plating solution usually includes a reducing agent and a metal salt, the reducing agent can be selected from the group consisting of hypophosphite, borohydride and hydrazine, the metal salt can be selected from the group consisting of nickel, copper, cobalt, tungsten, palladium, gold and platinum salt. The plating solution can also be added a stabilizer, the stabilizer can be selected from the group consisting of lead nitrate, lead acetate and thiourea.

The electroless or chemical plating has various baths, such as electroless nickel, electroless copper, electroless cobalt, electroless nickel-tungsten or electroless palladium etc.

### DETAILED DESCRIPTION OF THE INVENTION

In order to explicitly explain the present invention, several examples are illustrated as the follows.

### EXAMPLE 1

A piece of zinc-plated steel (65×50×1 mm) is immersed in hydrochloric acid solution (1:1 by volume) to remove the zinc layer, and then cleansed with water. Next, the steel specimen is dried by blowing with clean air and then weighted. A plating solution containing the following compound is prepared for plating the steel specimen.

| Nickel sulfate | 30 g/L |
|---|---|
| Sodium hypophosphite | 30 g/L |
| Glycine | 10 g/L |
| Sodium lactate | 40 g/L |
| Lead nitrate | 1.5 ppm |
| pH | 5.0 |

After being plated according to conditions as listed in Table 1 for one hour, the steel specimen is washed to remove the plating solution and then weighted. An average depositing rate, 13.7 μm/hr, can be obtained by repeating the same procedure for three times.

### EXAMPLES 2-5

Repeat the steps of Example 1, but the specimens are heated to different temperatures as listed in Table 1.

### EXAMPLES 6-8

Repeat the steps of Example 1, but the specimens are deposited in a plating bath without the stabilizer, lead nitrate. Depositing rates and stabilities of the bath are listed in Table 1.

### COMPARATIVE EXAMPLE 1

Repeat the steps of Example 1, but the specimen are plated at 90° C., the same as the bath. Depositing rates and stabilities of the bath are listed in Table 1.

### COMPARATIVE EXAMPLE 2

Repeat the steps of Example 1, but the specimens are plated at 90° C., the same as the bath, and no stabilizer is added therein.

TABLE 1

| | | Temp. | | | | | |
|---|---|---|---|---|---|---|---|
| | Temp. of | of steel | Conc. of | | | Depositing | Stability |
| | solution | piece | stabilizer | Hardness | Phosphorous | rate | of |
| | (° C.) | (° C.) | (ppm) | (Hv100) | (wt. %) | (μm/hr) | solution |
| Example 1 | 70 | 90 | 1.5 | 483 | 9.8 | 13.7 | Good |
| Example 2 | 70 | 100 | 1.5 | 536 | 9.6 | 26.2 | Good |
| Example 3 | 70 | 110 | 1.5 | 585 | 9.3 | 27.2 | Good |
| Example 4 | 70 | 120 | 1.5 | 585 | 9.3 | 27.4 | Good |
| Example 5 | 70 | 140 | 1.5 | 644 | 9.1 | 29.6 | Good |
| Example 6 | 70 | 90 | 0 | 491 | 9.9 | 14.7 | Good |
| Example 7 | 70 | 100 | 0 | 575 | 9.5 | 26.4 | Good |
| Example 8 | 70 | 110 | 0 | 578 | 9.5 | 29.4 | Good |
| Comparative | 90 | 90 | 1.5 | 493 | 10.2 | 16.2 | Good |
| Example 1 | | | | | | | |
| Comparative | 90 | 90 | 0 | 506 | 9.1 | 17.3 | No good |
| Example 2 | | | | | | | |

For Examples 1-8, though the bulk solution are kept at 70° C. which are lower than the steel pieces, superior depositing rates can be achieved. Particularly, when the temperatures of the steel pieces are higher than 100° C., the depositing rates can be doubled.

According to Examples 6-8 of the present invention, undesired spontaneous decomposition of the solution at high temperature can be avoided even no stabilizers are involved. Conversely, spontaneous decomposition occurs in Comparative Example 2 after plating for 30 minutes, which indicates that a stabilizer is necessary to the conventional technique.

The test results of deposits of Examples 1 and 6 also indicate that characteristics, such as hardness and phosphorus contents, are similar to that of Comparative Example 1; and the hardness of Examples 2-5, 7 and 8 can be particularly much better according to the present invention.

Although the present invention has been explained in relation to its preferred embodiment, it is to be understood that many other possible modifications and variations can be made without departing from the spirit and scope of the invention as hereinafter claimed.

What is claimed is:

1. A method for operating and controlling electroless plating, which comprises plating a substrate with a plating solution, said substrate is controlled at a constant temperature between 25° C. to 200° C., and said plating solution is kept at a lower temperature than that of said substrate.

2. The method as claimed in claim 1, wherein said constant temperature of said substrate is between 90° C. and 160° C., and the temperature of said plating solution is between 25° C. to 80° C.

3. The method as claimed in claim 1, wherein said plating solution comprises a reducing agent and a metal salt, said reducing agent is selected from the group consisting of hypophosphite, borohydride and hydrazine, said metal salt is selected from the group consisting of nickel, copper, cobalt, tungsten, palladium, gold and platinum salt.

4. The method as claimed in claim 1, wherein said plating solution further comprises a stabilizer, said stabilizer is selected from the group consisting of lead nitrate, lead acetate and thiourea.
